(19) United States
(12) Patent Application Publication
(10) Pub. No.: US 2018/0039139 A1
(43) Pub. Date: Feb. 8, 2018

(54) LIQUID CRYSTAL DISPLAY PANEL STRUCTURE AND MANUFACTURING METHOD THEREOF

(71) Applicant: Shenzhen China Star Optoelectronics Technology Co., Ltd., Shenzhen (CN)

(72) Inventor: Sikun HAO, Shenzhen (CN)

(21) Appl. No.: 15/033,654

(22) PCT Filed: Feb. 26, 2016
(86) PCT No.: PCT/CN2016/074684

§ 371 Date: May 2, 2016

(30) Foreign Application Priority Data
Jan. 13, 2016 (CN) 201610022133.8

(51) Int. Cl. G02F 1/1337; G02F 1/1335; G02F 1/1341; G02F 1/1343

(52) U.S. Cl. CPC G02F 1/133711; G02F 1/134309; G02F 1/133512; G02F 1/133784; G02F 1/133788; G02F 1/1341; G02F 2001/133715; G02F 2001/133738; G02F 2001/134372

(57) ABSTRACT

A liquid crystal display panel structure and a manufacturing method thereof are provided. The liquid crystal display panel structure has a first substrate, a second substrate, and a liquid crystal layer, wherein the first substrate is provided with a first transparent conductive layer and a first alignment film; the second substrate is provided with a second transparent conductive layer and a second alignment film; and the liquid crystal layer has a plurality of liquid crystal molecules. And, surfaces of the first alignment film and the second first alignment film respectively have a plurality of photo-reactive monomers. In the following electric current conduction and ultraviolet ray exposure processes, the photo-reactive monomers can fix an orientation of the liquid crystal molecules to be horizontal, so as to improve the contrast of the liquid crystal display of a Fringe Field Switching type.

### FIELD OF THE INVENTION

The present invention relates to a liquid crystal display panel structure and a manufacturing method thereof, and more particularly to a liquid crystal display panel structure and a manufacturing method thereof which can fix an orientation of liquid crystal molecules by disposing photo-reactive monomers on a surface of alignment films.

### BACKGROUND OF THE INVENTION

Liquid crystal displays (LCD) are now the most widely used flat panel displays, they have a high resolution color screen, and are widely applied to various electronic devices, such as mobile phones, personal digital assistants (PDA), digital cameras, computer displays, or laptop computer displays. Currently, a widely common used liquid crystal display is composed of upper and lower substrates and a middle liquid crystal layer, wherein the upper and lower substrates are composed of glass substrates and electrodes. If the upper and lower substrates both have electrodes, they can be formed as a kind of longitudinal electric field mode display, such as a TN (Twist Nematic) mode, a VA (Vertical Alignment) mode, and a MVA (Multi-Domain Vertical Alignment) mode which is developed to solve a problem of narrow viewing angle. In another kind of display, the electrodes are only disposed on the side of the lower substrate, and are formed as a kind of transverse electric field mode display, such as an IPS (In-Plane Switching), an FFS (Fringe Field Switching) mode, etc.

The above-mentioned FSS liquid crystal actuation mode is a wide viewing angle technology derived from the IPS actuation mode. In structural design, the FFS mode disposes a common electrode below an interval of pixel electrodes. When applying a voltage, a boundary electric field is generated to twist liquid crystal above the electrodes. By the boundary electric field, the almost evenly arranged liquid crystal molecules are twisted on the surface of the electrodes, so as to achieve a high penetration property and a large viewing angle characteristic. The electric field distribution of this kind has a greater vector in the z-direction, and also has a greater liquid crystal area which can be modulated, so that this electric field distribution design substantially increases a twisting power for the liquid crystal molecules in the liquid crystal flat panel display after applying the voltage, and improves defects of the IPS wide viewing angle technology, such as slow twisting speed, low aperture ratio, and requesting more backlight sources. Additionally, the FFS panel also has the widest viewing angle of all the wide viewing angle technologies.

Furthermore, there are many alignment methods used in the FFS liquid crystal display, wherein a rubbing alignment is the widest used method. The rubbing alignment not only has good optical characteristics, but also has good reliability at high temperature. However, because the rubbing alignment is according to a mechanical rubbing alignment between an alignment film and a rubbing cloth, the uniformity of the liquid crystal molecules on the surface of the alignment film is worse, so that it causes a dark-state light leakage, and then influences the contrast of the liquid crystal display. For example, refer now to FIGS. 1A to 1C, which are assembled schematic views of a traditional liquid crystal display panel structure. This traditional liquid crystal display panel structure 10 belongs to a liquid crystal display panel of a Fringe Field Switching (FFS) type, and mainly comprises an array substrate, a color filter substrate, and a liquid crystal layer, an assembled manufacturing method of which comprises following steps of:
(a) Refer to FIG. 1A, providing a first substrate 11, which includes a first alignment film 11a, wherein the first alignment film 11a is formed on a upper surface of the first substrate 11, and the first alignment film 11a of the first substrate 11 is rubbed and aligned by a rubbing roll A;
(b) Refer to FIG. 1B, providing a second substrate 12, which includes a second alignment film 12a, wherein the second alignment film 12a is formed on a upper surface of the second substrate 12, and the second alignment film 12a of the second substrate 12 is rubbed and aligned by a rubbing roll A;
(c) Refer to FIG. 1C, assembling the first substrate 11 and the second substrate 12 correspondingly, wherein the first alignment film 11a of the first substrate 11 and the second alignment film 12a of the second substrate 12 are facing inwardly and corresponding to each other; next, a liquid crystal layer 13 is injected between the first substrate 11 and the second substrate 12 (namely between the first alignment film 11a and the second alignment film 12a), and the liquid crystal layer 13 includes a plurality of liquid crystal molecules 13a; and because of an alignment effect of the first alignment film 11a of the first substrate 11 and the second alignment film 12a of the second substrate 12, an arrangement of the liquid crystal molecules 13a has a pretilt angle θ in the horizontal direction (a horizontal direction of the liquid crystal layer 13).

As mentioned above, the assembled manufacturing method of the traditional liquid crystal display panel structure 10 of a Fringe Field Switching (FFS) type will cause the liquid crystal molecules 13a therein producing a pretilt angle, and then influences the contrast of the liquid crystal display.

Hence, it is necessary to provide a liquid crystal display panel structure and a manufacturing method thereof, so as to solve the problems existing in a traditional liquid crystal display panel of the Fringe Field Switching type.

### SUMMARY OF THE INVENTION

The object of the present invention is to provide a method which improves a problem that the contrast of a liquid crystal display is decreased due to a rubbing alignment. After the method is used, the contrast of the rubbing alignment liquid crystal display is substantially increased.

To achieve the above object, the present invention provides a liquid crystal display panel structure, which comprises:
a first substrate including at least one first transparent conductive layer and a first alignment film, wherein the first alignment film is formed on an inner surface of the first substrate;
a second substrate disposed corresponding to the first substrate and including at least one second transparent conductive layer and a second alignment film, wherein the second alignment film is formed on an inner surface of the second substrate, and is disposed corresponding to the first alignment film of the first substrate; and
a liquid crystal layer including a plurality of liquid crystal molecules and disposed between the first substrate and the second substrate;
wherein the surfaces of the first alignment film and the second alignment film respectively have a plurality of photo-reactive monomers which fix an orientation of the liquid crystal molecules, so that the orientation of the liquid crystal molecules is horizontal in relation to the liquid crystal layer.

In one embodiment of the present invention, the first substrate is an array substrate, and the second substrate is a color filter substrate.

In one embodiment of the present invention, the first transparent conductive layer is a pixel electrode layer, and the first alignment film is disposed on the pixel electrode layer.

In one embodiment of the present invention, the second transparent conductive layer is an electrostatic shielding layer disposed on a back surface of the second substrate.

In one embodiment of the present invention, the first substrate has two of the transparent conductive layers, including of a pixel electrode layer and a common electrode layer, and wherein a passivation layer is disposed between the pixel electrode layer and the common electrode layer.

To achieve the above object, the present invention further provides a manufacturing method of a liquid crystal display panel structure, which comprises steps of:
(a) providing a first substrate, wherein the first substrate includes at least one first transparent conductive layer and a first alignment film, and the first alignment film is formed on a upper surface of the first substrate;
(b) processing a rubbing alignment on the first alignment film of the first substrate;
(c) providing a second substrate, wherein the second substrate includes at least one second transparent conductive layer and a second alignment film, and the second alignment film is formed on a upper surface of the second substrate;
(d) executing a rubbing alignment on the second alignment film of the second substrate;
(e) assembling the first substrate and the second substrate correspondingly, wherein the first alignment film of the first substrate and the second alignment film of the second substrate are facing inwardly and corresponding to each other;
(f) injecting a liquid crystal layer between the first substrate and the second substrate, wherein the liquid crystal layer includes a plurality of liquid crystal molecules and a plurality of photo-reactive monomers; and the liquid crystal molecules are arranged by an alignment effect of the first alignment film of the first substrate and the second alignment film of the second substrate, and each of the liquid crystal molecules has a pretilt angle θ in relation to a horizontal direction of the liquid crystal layer;
(g) executing an electric current conduction process to the first transparent conductive layer of the first substrate and the second transparent conductive layer of the second substrate, so that a longitudinal electric field is formed between the first substrate and the second substrate;
(h) applying an ultraviolet ray exposure when applying the longitudinal electric field, wherein the photo-reactive monomers of the liquid crystal layer are adhered to the surfaces of the first alignment film and the second alignment film, so as to fix an orientation of the liquid crystal molecules of the liquid crystal layer, and to eliminate the pretilt angle of the liquid crystal molecules, until the orientation of the liquid crystal molecules is horizontal in relation to the liquid crystal layer; and
(i) removing the longitudinal electric field and the ultraviolet ray exposure, wherein the orientation of the liquid crystal molecules is kept horizontal.

In one embodiment of the present invention, the first substrate is an array substrate, and the second substrate is a color filter substrate.

In one embodiment of the present invention, the first transparent conductive layer is a pixel electrode layer, and the first alignment film is disposed on the pixel electrode layer.

In one embodiment of the present invention, the second transparent conductive layer is an electrostatic shielding layer disposed on a back surface of the second substrate.

In one embodiment of the present invention, the first substrate has two of the transparent conductive layers, including of a pixel electrode layer and a common electrode layer, and wherein a passivation layer is disposed between the pixel electrode layer and the common electrode layer.

In one embodiment of the present invention, the electric current conduction process is a direct current conduction process or an alternating current conduction process.

To achieve the above object, the present invention further provides a manufacturing method of a liquid crystal display panel structure, which comprises steps of:
(a) providing a first substrate, wherein the first substrate includes at least one first transparent conductive layer and a first alignment film; the first alignment film is formed on a upper surface of the first substrate; and a plurality of photo-reactive monomers are mixed into the first alignment film;
(b) processing a rubbing alignment on the first alignment film of the first substrate;
(c) providing a second substrate, wherein the second substrate includes at least one second transparent conductive layer and a second alignment film; the second alignment film is formed on a upper surface of the second substrate; and a plurality of photo-reactive monomers are mixed into the second alignment film;
(d) executing a rubbing alignment on the second alignment film of the second substrate;
(e) assembling the first substrate and the second substrate correspondingly, wherein the first alignment film of the first substrate and the second alignment film of the second substrate are facing inwardly and corresponding to each other;
(f) injecting a liquid crystal layer between the first substrate and the second substrate, wherein the liquid crystal layer includes a plurality of liquid crystal molecules; and the liquid crystal molecules are arranged by an alignment effect of the first alignment film of the first substrate and the second alignment film of the second substrate, and each of the liquid crystal molecules has a pretilt angle θ in relation to a horizontal direction of the liquid crystal layer;
(g) executing an electric current conduction process to the first transparent conductive layer of the first substrate and the second transparent conductive layer of the second substrate, so that a longitudinal electric field is formed between the first substrate and the second substrate;
(h) applying an ultraviolet ray exposure when applying the longitudinal electric field, wherein the photo-reactive monomers of the first alignment film of the first substrate and the second alignment film of the second substrate are reacted thereon respectively, so as to fix an orientation of the liquid crystal molecules of the liquid crystal layer, and to eliminate the pretilt angle of the liquid crystal molecules, until the orientation of the liquid crystal molecules is horizontal in relation to the liquid crystal layer; and
(i) removing the longitudinal electric field and the ultraviolet ray exposure, wherein the orientation of the liquid crystal molecules is kept horizontal.

In one embodiment of the present invention, the first substrate is an array substrate, and the second substrate is a color filter substrate.

In one embodiment of the present invention, the first transparent conductive layer is a pixel electrode layer, and the first alignment film is disposed on the pixel electrode layer.

In one embodiment of the present invention, the second transparent conductive layer is an electrostatic shielding layer disposed on a back surface of the second substrate.

In one embodiment of the present invention, the first substrate has two of the transparent conductive layers, including of a pixel electrode layer and a common electrode layer, and wherein a passivation layer is disposed between the pixel electrode layer and the common electrode layer.

In one embodiment of the present invention, the electric current conduction process is a direct current conduction process or an alternating current conduction process.

### DESCRIPTION OF THE DRAWINGS

FIGS. 1A-1C are assembled schematic views of a traditional liquid crystal display panel structure;

FIGS. 2A-2F are assembled schematic views of a liquid crystal display panel structure according to a first embodiment of the present invention;

FIGS. 3A-3F are assembled schematic views of a liquid crystal display panel structure according to a second embodiment of the present invention; and

FIG. 4 is an assembled schematic view of a liquid crystal display panel structure according to a third embodiment of the present invention.

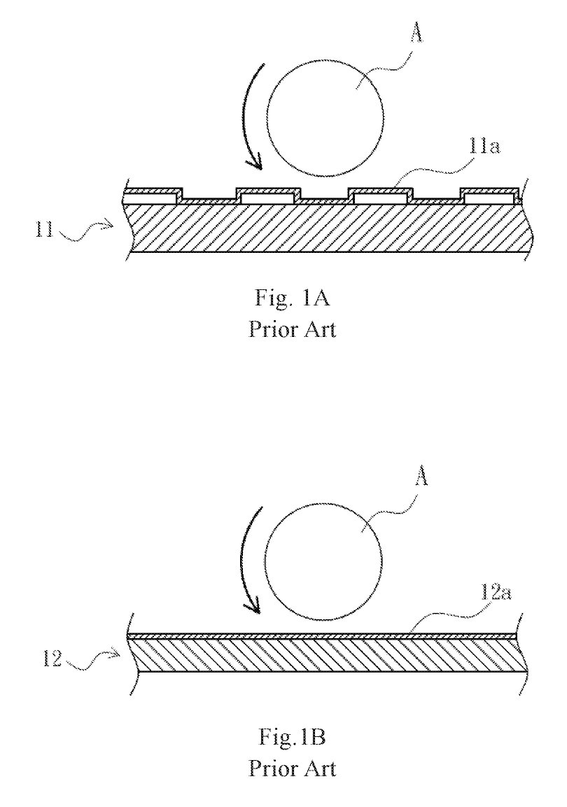

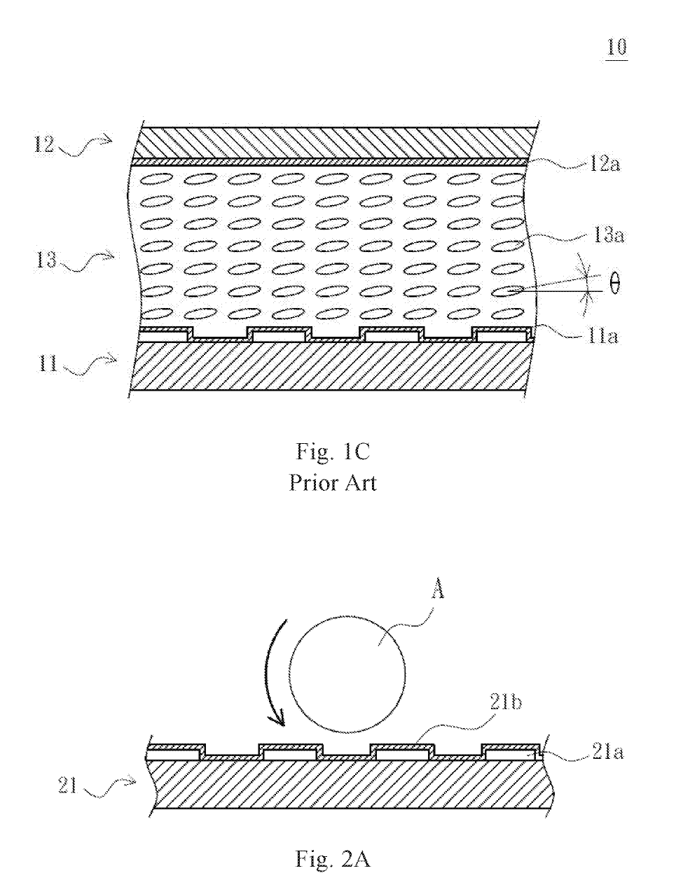

### DETAILED DESCRIPTION OF THE PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inside, outer, side, etc., are only directions with reference to the accompanying drawings, so that the used directional terms are used to describe and understand the present invention, but the present invention is not limited thereto. In the drawings, units with similar structures use the same numerals.

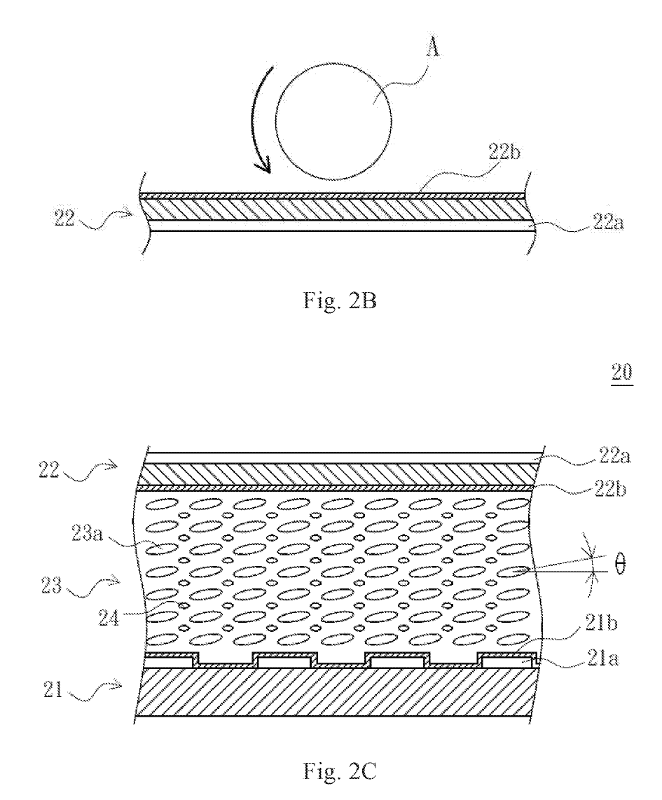

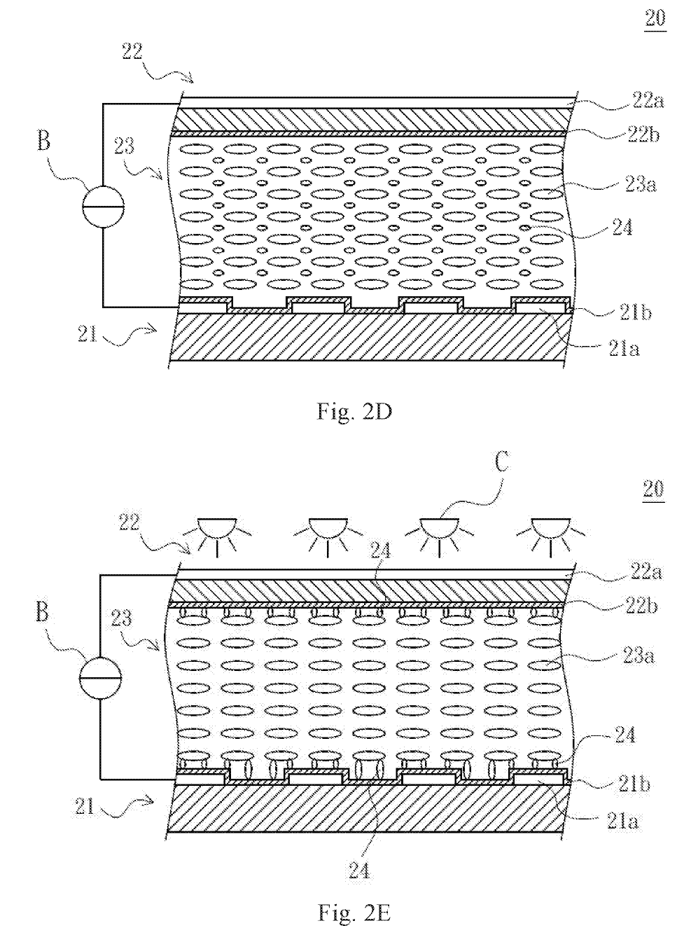

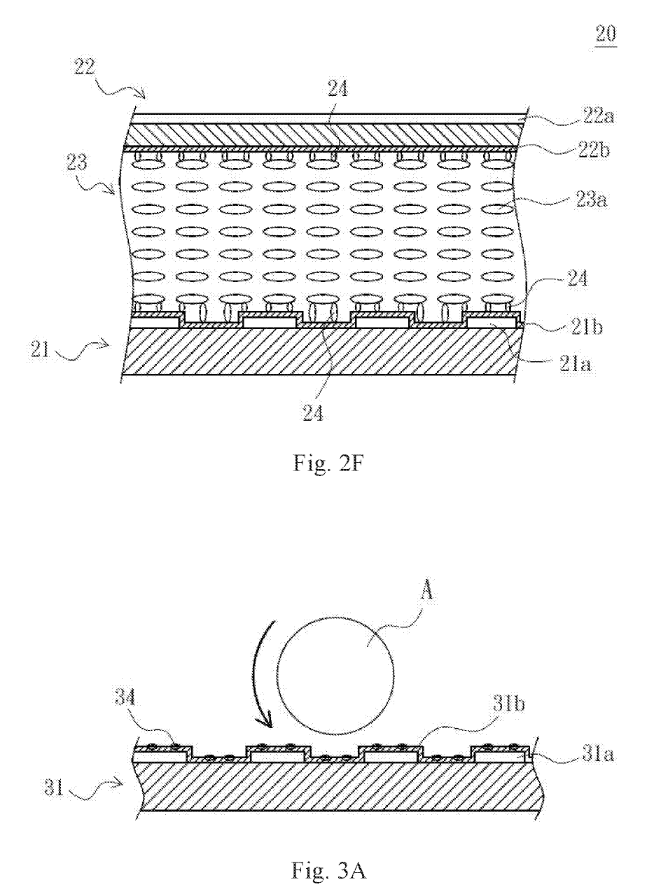

Refer now to FIGS. 2A-2F, which are assembled schematic views of a liquid crystal display panel structure according to a first embodiment of the present invention. A liquid crystal display panel structure 20 according to the present invention belongs to a liquid crystal display panel of a Fringe Field Switching (FFS) type, and mainly comprises an array substrate, a color filter substrate, and a liquid crystal layer. An assembled manufacturing method of the liquid crystal display panel structure 20 comprises the following steps of:
(a) Refer to FIG. 2A, providing a first substrate 21, wherein the first substrate 21 includes a first transparent conductive layer 21a and a first alignment film 21b, and the first alignment film 21b is formed on a upper surface of the first substrate 21;
(b) Continue to refer to FIG. 2A, processing a rubbing alignment on the first alignment film 21b of the first substrate 21;
(c) Refer to FIG. 2B, providing a second substrate 22, wherein the second substrate 22 includes a second transparent conductive layer 22a and a second alignment film 22b, and the second alignment film 22b is formed on a upper surface of the second substrate 22;
(d) Continue to refer to FIG. 2B, executing a rubbing alignment on the second alignment film 22b of the second substrate 22;
(e) Refer to FIG. 2C, assembling the first substrate 21 and the second substrate 22 correspondingly, wherein the first alignment film 21b of the first substrate 21 and the second alignment film 22b of the second substrate 22 are facing inwardly and corresponding to each other; that is they respectively define and form inner surfaces of the first substrate 21 and the second substrate 22;
(f) Continue to refer to FIG. 2C, injecting a liquid crystal layer 23 between the first substrate 21 and the second substrate 22 (namely between the first alignment film 21b of the first substrate 21 and the second alignment film 22b of the second substrate 22), wherein the liquid crystal layer 23 includes a plurality of liquid crystal molecules 23a and a plurality of photo-reactive monomers 24; and the liquid crystal molecules 23a are arranged by an alignment effect of the first alignment film 21b of the first substrate 21 and the second alignment film 22b of the second substrate 22, and each of the liquid crystal molecules 23a has a pretilt angle θ in relation to a horizontal direction (a horizontal direction of a vertical cross section of the liquid crystal layer 23);
(g) Refer to FIG. 2D, executing an electric current conduction process to the first transparent conductive layer 21a of the first substrate 21 and the second transparent conductive layer 22a of the second substrate 22 (a direct current is used in this embodiment), so that a longitudinal electric field is formed between the first substrate 21 and the second substrate 22;
(h) Refer to FIG. 2E, applying a ultraviolet ray exposure when applying the longitudinal electric field, wherein the photo-reactive monomers 24 of the liquid crystal layer 23 are produced a phase separation, and adhered to the surfaces of the first alignment film 21b and the second alignment film 22b, so as to fix an orientation of the liquid crystal molecules 23a of the liquid crystal layer 23, and to eliminate the pretilt angle of the liquid crystal molecules 23a, until the orientation of the liquid crystal molecules 23a is horizontal in relation to the liquid crystal layer 23 thereby; and
(i) Refer to FIG. 2F, removing the longitudinal electric field and the ultraviolet ray exposure, wherein the orientation of the liquid crystal molecules 23a is kept horizontal (approaching horizontal).

By the above-mentioned assembled manufacturing steps, a liquid crystal display panel structure 20 according to the present invention (as shown in FIG. 2F) is therefore accomplished, and comprises: a first substrate 21, a second substrate 22, and a liquid crystal layer 23, wherein the first substrate 21 includes a first transparent conductive layer 21a and a first alignment film 21b, and the first alignment film 21b is formed on an inner surface of the first substrate 21; the second substrate 22 disposed corresponding to the first substrate 21 includes a second transparent conductive layer 22a and a second alignment film 22b, and the second alignment film 22b is formed on an inner surface of the second substrate 22 and is corresponding to the first alignment film 21b of the first substrate 21; the liquid crystal layer 23 including a plurality of liquid crystal molecules 23a is disposed between the first substrate 21 and the second substrate 22 (namely between the first alignment film 21b of the first substrate 21 and the second alignment film 22b of the second substrate 22); and the surfaces of the first alignment film 21b and the second alignment film 22b respectively has a plurality of photo-reactive monomers 24 which can fix the orientation of the liquid crystal molecules 23a, so that the orientation of the liquid crystal molecules 23a is horizontal.

Preferably, the first substrate 21 is an array substrate, and the second substrate 22 is a color filter substrate.

Preferably, the first transparent conductive layer 21a is a pixel electrode layer, and the first alignment film 21b is disposed on the pixel electrode layer; and the second transparent conductive layer 22a is an electrostatic shielding layer disposed on a back surface of the second substrate 22. Additionally, in this embodiment, the number of the transparent conductive layers 21a, 22a of the first substrate 21 and the second substrate 22 both are one (at least one), but in other possible embodiments of the present invention, the first substrate 21 and the second substrate 22 can include more than one of the transparent conductive layer.

Furthermore, the electric current conduction process can be a direct current (DC) conduction process or an alternating current (AC) conduction process, and is not limited in the present invention.

As mentioned above, in the foregoing assembled manufacturing steps, and in the liquid crystal display panel structure 20 according to the present invention, because the liquid crystal layer 23 includes the photo-reactive monomers 24, so that in the following electric current conduction and ultraviolet ray exposure processes, the photo-reactive monomers 24 can be adhered to the first alignment film 21b and the second alignment film 22b, and can fix the orientation of the liquid crystal molecules 23a to be horizontal, so as to improve the contrast of the liquid crystal display of the Fringe Field Switching type.

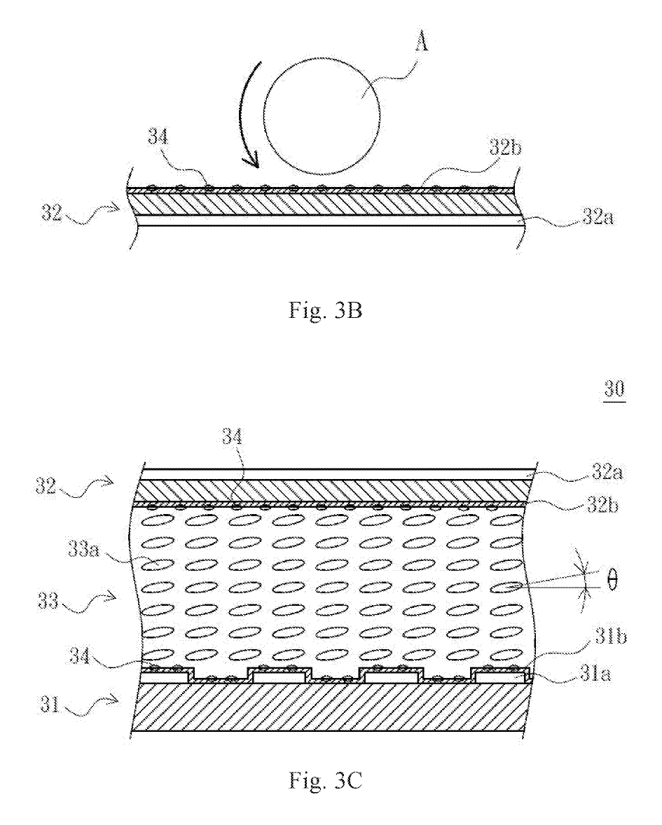

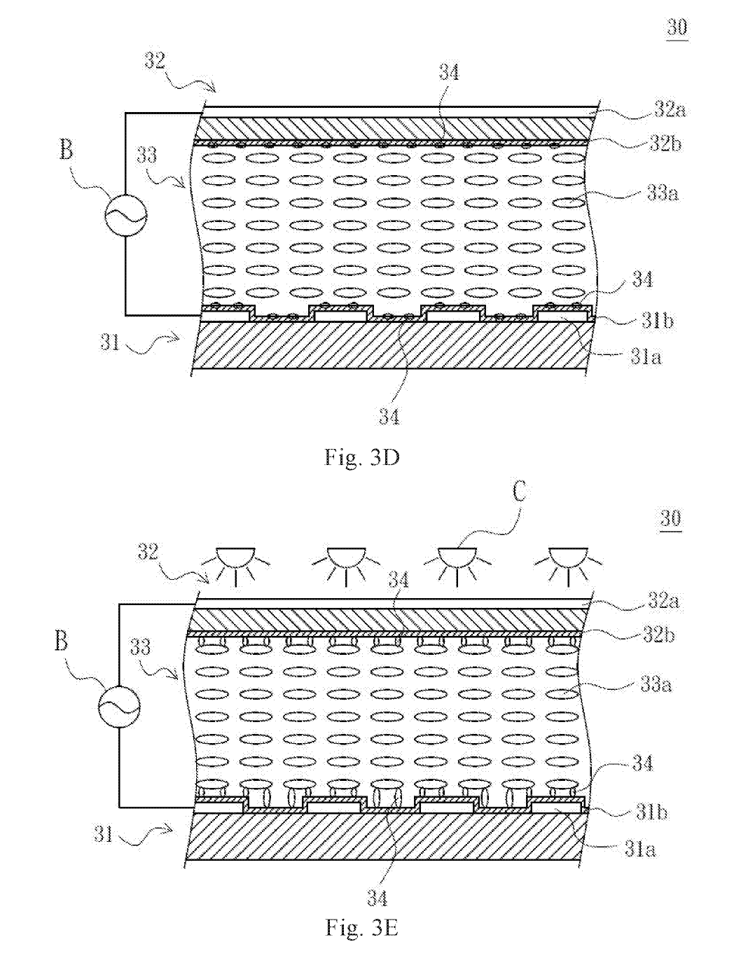

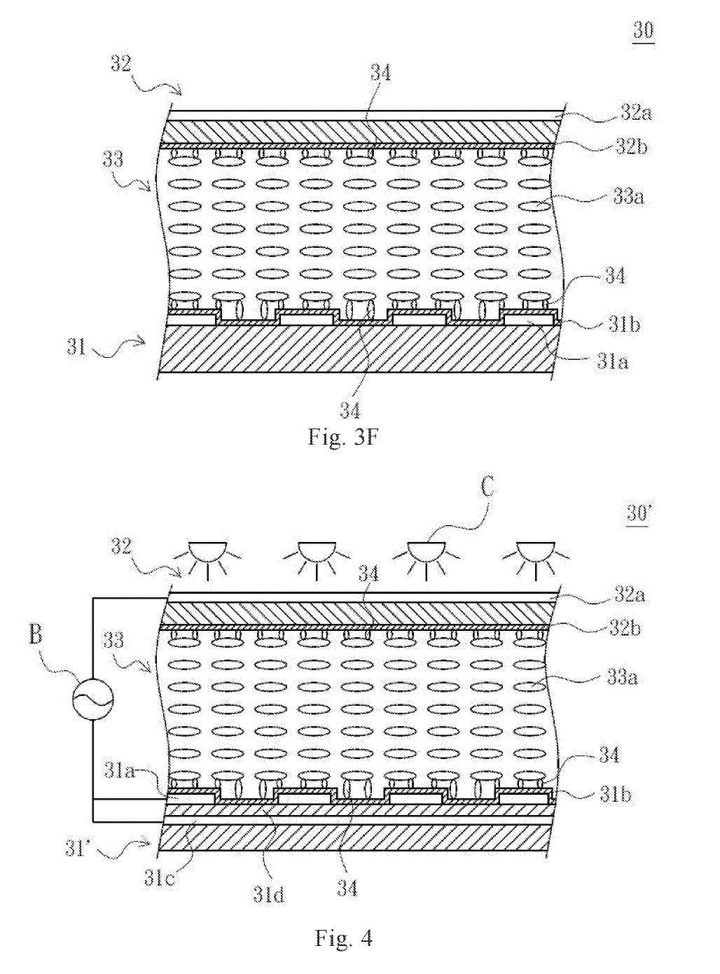

Refer now to FIGS. 3A-3F, which are assembled schematic views of a liquid crystal display panel structure according to a second embodiment of the present invention. An assembled manufacturing method of the liquid crystal display panel structure 30 according to the second embodiment of the present invention comprises the following steps of:
(a) Providing a first substrate 31, wherein the first substrate 31 includes a first transparent conductive layer 31a and a first alignment film 31b; the first alignment film 31b is formed on a upper surface of the first substrate 31; and a plurality of photo-reactive monomers 34 are mixed into the first alignment film 31b;
(b) Processing a rubbing alignment on the first alignment film 31b of the first substrate 31;
(c) Providing a second substrate 32, wherein the second substrate 32 includes a second transparent conductive layer 32a and a second alignment film 32b; the second alignment film 32b is formed on a upper surface of the second substrate 32; and a plurality of photo-reactive monomers 34 are mixed into the second alignment film 32b;
(d) Executing a rubbing alignment on the second alignment film 32b of the second substrate 32;
(e) Assembling the first substrate 31 and the second substrate 32 correspondingly, wherein the first alignment film 31b of the first substrate 31 and the second alignment film 32b of the second substrate 32 are facing inwardly and corresponding to each other; that is they respectively define and form inner surfaces of the first substrate 31 and the second substrate 32;
(f) Injecting a liquid crystal layer 33 between the first substrate 31 and the second substrate 32 (namely between the first alignment film 31b of the first substrate 31 and the second alignment film 32b of the second substrate 32), wherein the liquid crystal layer 33 includes a plurality of liquid crystal molecules 33a; and the liquid crystal molecules 33a are arranged by an alignment effect of the first alignment film 31b of the first substrate 31 and the second alignment film 32b of the second substrate 32, and each of the liquid crystal molecules 33a has a pretilt angle θ in relation to a horizontal direction (a horizontal direction of a vertical cross section of the liquid crystal layer 33);
(g) Executing an electric current conduction process to the first transparent conductive layer 31a of the first substrate 31 and the second transparent conductive layer 32a of the second substrate 32 (an alternating current is used in this embodiment), so that a longitudinal electric field is formed between the first substrate 31 and the second substrate 32;
(h) Applying an ultraviolet ray exposure when applying the longitudinal electric field, wherein the photo-reactive monomers 34 of the first alignment film 31b of the first substrate 31 and the second alignment film 32b of the second substrate 32 are reacted thereon respectively, and are bound with main chains or side chains of the liquid crystal molecules 33a of the liquid crystal layer 33, so as to fix an orientation of the liquid crystal molecules 33a of the liquid crystal layer 33, and to eliminate the pretilt angle of the liquid crystal molecules 33a, until the orientation of the liquid crystal molecules 33a is horizontal in relation to the liquid crystal layer 33 thereby; and
(i) Removing the longitudinal electric field and the ultraviolet ray exposure, wherein the orientation of the liquid crystal molecules 33a is kept horizontal (approaching horizontal).

As mentioned above, in the foregoing assembled manufacturing steps, and in the liquid crystal display panel structure 30 according to the present invention, because the photo-reactive monomers 34 are mixed into the first alignment film 31b and the second alignment film 32b, so that in the following electric current conduction and ultraviolet ray exposure processes, the photo-reactive monomers 34 can fix the orientation of the liquid crystal molecules 33a to be horizontal, so as to improve the contrast of the liquid crystal display of the Fringe Field Switching type.

Referring now to FIG. 4, which is an assembled schematic view of a liquid crystal display panel structure according to a third embodiment of the present invention. A liquid crystal display panel structure according to the third embodiment of the present invention is similar to the liquid crystal display panel structure according to the second embodiment of the present invention, thus using similar terms and numerals to the foregoing embodiment, the difference between the liquid crystal display panel structure 30′ according to the third embodiment of the present invention and the liquid crystal display panel structure 30 according to the second embodiment of the present invention is that: the first substrate 31′ has two of the transparent conductive layers, wherein the first transparent conductive layer 31a is a pixel electrode layer; another transparent conductive layer 31c is a common electrode layer; and wherein a passivation layer 31d is disposed between the pixel electrode layer and the common electrode layer. Therefore, when executing the electric current conduction process, the two of the transparent conductive layers (the pixel electrode layer and the common electrode layer) are applied to the voltage of the same polarity, namely the pixel electrode layer and the common electrode layer are parallel connection in an electric circuit, so as to further increase the effect of the longitudinal electric field when conducting the electric current.

The present invention has been described with preferred embodiments thereof and it is understood that many changes and modifications to the described embodiments can be carried out without departing from the scope and the spirit of the invention that is intended to be limited only by the appended claims.

What is claimed is:

1. A liquid crystal display panel structure, comprising:
a first substrate including at least one first transparent conductive layer and a first alignment film, wherein the first alignment film is formed on an inner surface of the first substrate;
a second substrate disposed corresponding to the first substrate and including at least one second transparent conductive layer and a second alignment film,
wherein the second alignment film is formed on an inner surface of the second substrate, and is disposed corresponding to the first alignment film of the first substrate; and
a liquid crystal layer including a plurality of liquid crystal molecules, and disposed between the first substrate and the second substrate;
wherein surfaces of the first alignment film and the second alignment film respectively have a plurality of photo-reactive monomers which fix the orientation of the liquid crystal molecules, so that an orientation of the liquid crystal molecules is horizontal in relation to the liquid crystal layer.

2. The liquid crystal display panel structure according to claim 1, wherein the first substrate is an array substrate, and the second substrate is a color filter substrate.

3. The liquid crystal display panel structure according to claim 1, wherein the first transparent conductive layer is a pixel electrode layer, and the first alignment film is disposed on the pixel electrode layer.

4. The liquid crystal display panel structure according to claim 1, wherein the second transparent conductive layer is an electrostatic shielding layer disposed on a back surface of the second substrate.

5. The liquid crystal display panel structure according to claim 1, wherein the first substrate has two of the transparent conductive layers, including of a pixel electrode layer and a common electrode layer, and wherein a passivation layer is disposed between the pixel electrode layer and the common electrode layer.

6. An manufacturing method of a liquid crystal display panel structure, comprising steps of:
(a) providing a first substrate, wherein the first substrate includes at least one first transparent conductive layer and a first alignment film, and the first alignment film is formed on a upper surface of the first substrate;
(b) processing a rubbing alignment on the first alignment film of the first substrate;
(c) providing a second substrate, wherein the second substrate includes at least one second transparent conductive layer and a second alignment film, and the second alignment film is formed on a upper surface of the second substrate;
(d) executing a rubbing alignment on the second alignment film of the second substrate;
(e) assembling the first substrate and the second substrate correspondingly, wherein the first alignment film of the first substrate and the second alignment film of the second substrate are facing inwardly and corresponding to each other;
(f) injecting a liquid crystal layer between the first substrate and the second substrate, wherein the liquid crystal layer includes a plurality of liquid crystal molecules and a plurality of photo-reactive monomers; and the liquid crystal molecules are arranged by an alignment effect of the first alignment film of the first substrate and the second alignment film of the second substrate, and each of the liquid crystal molecules has a pretilt angle θ in relation to a horizontal direction of the liquid crystal layer;
(g) executing an electric current conduction process to the first transparent conductive layer of the first substrate and the second transparent conductive layer of the second substrate, so that a longitudinal electric field is formed between the first substrate and the second substrate;
(h) applying an ultraviolet ray exposure when applying the longitudinal electric field, wherein the photo-reactive monomers of the liquid crystal layer are adhered to surfaces of the first alignment film and the second alignment film, so as to fix an orientation of the liquid crystal molecules of the liquid crystal layer, and to eliminate the pretilt angle of the liquid crystal molecules, until the orientation of the liquid crystal molecules is horizontal in relation to the liquid crystal layer; and
(i) removing the longitudinal electric field and the ultraviolet ray exposure, wherein the orientation of the liquid crystal molecules is kept horizontal.

7. The manufacturing method of the liquid crystal display panel structure according to claim 6, wherein the first substrate is an array substrate, and the second substrate is a color filter substrate.

8. The manufacturing method of the liquid crystal display panel structure according to claim 6, wherein the first transparent conductive layer is a pixel electrode layer, and the first alignment film is disposed on the pixel electrode layer.

9. The manufacturing method of the liquid crystal display panel structure according to claim 6, wherein the second transparent conductive layer is an electrostatic shielding layer disposed on a back surface of the second substrate.

10. The manufacturing method of the liquid crystal display panel structure according to claim 6, wherein the first substrate has two of the transparent conductive layers, including of a pixel electrode layer and a common electrode layer, and wherein a passivation layer is disposed between the pixel electrode layer and the common electrode layer.

11. The manufacturing method of the liquid crystal display panel structure according to claim 6, wherein the electric current conduction process is a direct current conduction process or an alternating current conduction process.

12. An manufacturing method of a liquid crystal display panel structure, comprising steps of:
(a) providing a first substrate, wherein the first substrate includes at least one first transparent conductive layer and a first alignment film; the first alignment film is formed on a upper surface of the first substrate; and a plurality of photo-reactive monomers are mixed in the first alignment film;
(b) processing a rubbing alignment on the first alignment film of the first substrate;
(c) providing a second substrate, wherein the second substrate includes at least one second transparent conductive layer and a second alignment film; the second alignment film is formed on a upper surface of the second substrate; and a plurality of photo-reactive monomers are mixed in the second alignment film;
(d) executing a rubbing alignment on the second alignment film of the second substrate;
(e) assembling the first substrate and the second substrate correspondingly, wherein the first alignment film of the first substrate and the second alignment film of the second substrate are facing inwardly and corresponding to each other;
(f) injecting a liquid crystal layer between the first substrate and the second substrate, wherein the liquid crystal layer includes a plurality of liquid crystal molecules; and the liquid crystal molecules are arranged by an alignment effect of the first alignment film of the first substrate and the second alignment film of the second substrate, and each of the liquid crystal molecules has a pretilt angle θ in relation to a horizontal direction of the liquid crystal layer;
(g) executing an electric current conduction process to the first transparent conductive layer of the first substrate and the second transparent conductive layer of the second substrate, so that a longitudinal electric field is formed between the first substrate and the second substrate;
(h) applying an ultraviolet ray exposure when applying the longitudinal electric field, wherein the photo-reactive monomers of the first alignment film of the first substrate and the second alignment film of the second substrate are reacted thereon respectively, so as to fix an orientation of the liquid crystal molecules of the liquid crystal layer, and to eliminate the pretilt angle of the liquid crystal molecules, until the orientation of the liquid crystal molecules is horizontal in relation to the liquid crystal layer; and
(i) removing the longitudinal electric field and the ultraviolet ray exposure, wherein the orientation of the liquid crystal molecules is kept horizontal.

13. The manufacturing method of the liquid crystal display panel structure according to claim 12, wherein the first substrate is an array substrate, and the second substrate is a color filter substrate.

14. The manufacturing method of the liquid crystal display panel structure according to claim 12, wherein the first transparent conductive layer is a pixel electrode layer, and the first alignment film is disposed on the pixel electrode layer.

15. The manufacturing method of the liquid crystal display panel structure according to claim 12, wherein the second transparent conductive layer is an electrostatic shielding layer disposed on a back surface of the second substrate.

16. The manufacturing method of the liquid crystal display panel structure according to claim 12, wherein the first substrate has two of the transparent conductive layers, including of a pixel electrode layer and a common electrode layer, and wherein a passivation layer is disposed between the pixel electrode layer and the common electrode layer.

17. The manufacturing method of the liquid crystal display panel structure according to claim 12, wherein the electric current conduction process is a direct current conduction process or an alternating current conduction process.
